(19) United States
(12) Patent Application Publication
(10) Pub. No.: US 2004/0194621 A1
(43) Pub. Date: Oct. 7, 2004

(54) Lower part for a multi piece piston

(76) Inventor: Christoph Geissler, Freudenstadt (DE)

Correspondence Address: WILLIAM COLLARD, COLLARD & ROE, P.C., 1077 NORTHERN BOULEVARD, ROSLYN, NY, 11576, US

(21) Appl. No.: 10/467,881

(22) PCT Filed: Dec. 5, 2001
(86) PCT No.: PCT/DE01/04615

(30) Foreign Application Priority Data
Feb. 13, 2001 (DE) 101 06 578.7

(51) Int. Cl. F16J 1/04

(52) U.S. Cl. 92/222

(57) ABSTRACT

The aim of the invention is to produce a multi-piece piston with a sufficient shaft length in a simple manner. To achieve this, the lower part (1) has the following characteristics:—it consists of two halves (2,3) that have been welded or soldered together,—the parting plane (4) between the two halves (2,3) runs in the pressure-counter-pressure direction—the two halves (2,3) consist of extruded or forged steel the diameter of the shaft (5) in the direction of the pin is reduced in relation to the diameter of the piston, in the manner a box piston.

The invention relates to a lower part for a multi-piece piston according to the preamble of Claim 1.

Until now, such lower parts were structured either as gray cast iron parts or as pressed aluminum parts. Recently, the trend has been in the direction of forged, single-piece steel lower parts, for reasons of strength. However, these have the disadvantage that only limited shaft lengths can be produced.

The invention therefore concerns itself with the problem of making available lower parts having sufficient strength and an unrestricted shaft length. This problem is solved by means of a lower part having the characterizing features of Claim 1. Advantageous further developments are the object of the dependent claims.

Electron-beam welding, linear friction welding, diffusion welding, hard soldering, and the like, in particular, are possible connection methods for the lower part halves.

The invention will be described in the following, using an exemplary embodiment. The drawing shows:

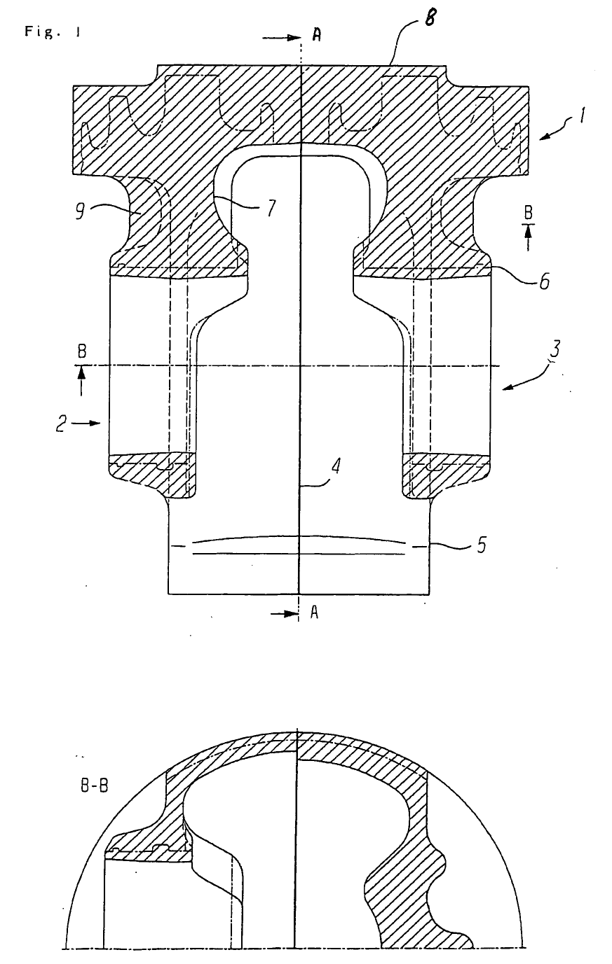

FIG. 1 a lower part according to the invention, in cross-section in the rod direction,

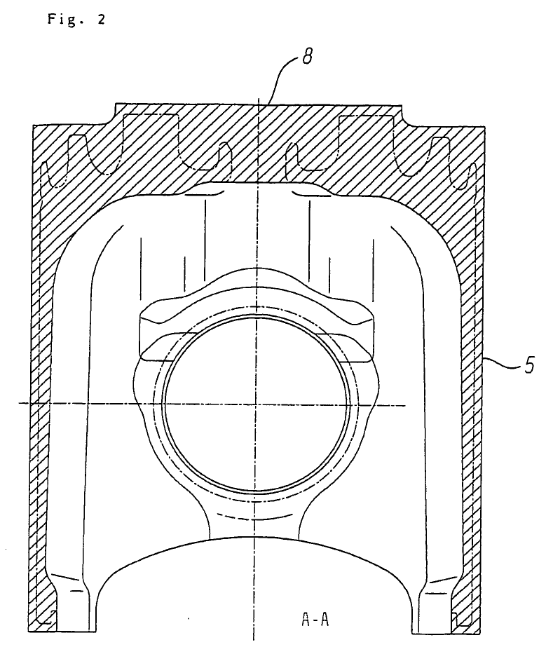

FIG. 2 a lower part according to the invention, with the cross-section in the parting plane.

The steel lower part 1 consists of two forged halves 2 and 3, which are welded together in the parting plane 4 by means of an electron beam. It has a shaft 5, hub 6, support regions 7 and a lower part head 8. Weight-reducing recesses 9 are made in the region to the side of and above the hubs, by means of forging.

The finished lower part (contours shown with a dot-dash line) is later screwed onto a piston head and is used in large engines, for example large ship engines.

1. Lower part (1) for a multi-piece piston, having hubs (6), a shaft (5), and support regions (7), as well as a lower part head (8),
characterized by the features that
the lower part (1) consists of two halves (2, 3) that have been welded or soldered together,
the parting plane (4) between the two halves (2, 3) runs in the pressure-counter-pressure direction,
the two halves (2, 3) consist of extruded or forged steel,
the shaft (5) is reduced in diameter in relation to the piston diameter in the pin direction, in the manner of a box piston.

2. Lower part for a multi-piece piston according to claim 1,
characterized in that
the two halves (2, 3) are connected by means of electron-beam welding, linear friction welding, diffusion welding, or hard soldering.

3. Lower part for a multi-piece piston according to claim 1,
characterized in that
recesses (9) are present in the region around the hubs (6).

4. Lower part for a multi-piece piston according to claim 1,
characterized in that
the parting plane (4) between the two halves (2, 3) agrees precisely with a plane of symmetry of the lower part.

5. Method for the production of a lower part for a multi-piece piston according to claim 1,
characterized in that
the pin hole is pre-forged.
